(19) United States
(12) Patent Application Publication
(10) Pub. No.: US 2005/0183604 A1
(43) Pub. Date: Aug. 25, 2005

(54) Apparatus and method for controlling ink or paint temperature in a printing device

(76) Inventors: Brian Bruno, Clemson, SC (US); Greg Gianforcaro, Clemson, SC (US); Jeremy Hedrick, Borden, IN (US)

Correspondence Address: Mark D. Lorusso;LORUSSO & LOUD, 15 Rye Street, Suite 312, Portsmouth, NH, 03801, US

(21) Appl. No.: 10/911,613

(22) Filed: Aug. 5, 2004

Related U.S. Application Data
(60) Provisional application No. 60/492,503, filed on Aug. 5, 2003.

(51) Int. Cl. B41F 9/01; B41F 31/00

(52) U.S. Cl. 101/487; 101/163

(57) ABSTRACT

Apparatus and methods of controlling the temperature of printing ink or paint in a pad printing apparatus are described. The apparatus comprise temperature control elements that are connected to a chiller unit. Temperature sensors on a support plate or ink cup, or both monitor the temperature of the ink cup and/or ink. As the temperature of the ink in an ink cup rises due to ambient air temperature in the working environment, a chill medium is applied to the support plate, ink cup, ink or any combination thereof to cool the temperature of the ink thereby reducing evaporation of solvents in the ink to maintain a relatively constant ink viscosity.

### CROSS-REFERENCE TO RELATED APPLICATIONS

A claim of benefit is made to U.S. provisional application Ser. No. 60/492,503, filed Aug. 5, 2003, the contents of which are incorporated herein by reference.

### FIELD OF THE INVENTION

The present invention relates generally to printing, and more particularly, to an improved control of ink or paint temperature in a pad transfer printing device.

### BACKGROUND OF THE INVENTION

In the golf ball industry, the surface of a golf ball usually bears a mark, such as a number, a manufacturer name, and the like. Conventionally, the marked portion is formed on the golf ball surface primarily by a transfer printing method or a pad printing method. In the transfer printing method, a transfer foil which has been formed on transfer paper through printing is transferred onto a marking-portion forming surface of the golf ball through application of heat and pressure. Pad printing is used for printing images on curved or other non-flat surfaces such as spherical, conical, cylindrical and other curved objects.

Typically, with pad transfer printing, an inked image is lifted from the engraved area of an engraved printing plate, sometimes referred to as a cliche plate, and is transferred to a surface to be printed by a resilient ink transfer pad, normally made of silicone rubber. The surface characteristics of the silicone rubber are such that the ink easily releases from the pad and adheres to the print receiving surface. The transfer pad typically can elastically deform during printing so that virtually any type of raised or irregular shaped surface can be printed, in addition to flat surfaces.

Both open and closed reservoir ink assemblies are known which may be employed in a pad transfer printing apparatus. With an open-reservoir ink assembly, typically, the ink is held in an open trough or reservoir. The engraved area of the printing plate is filled by taking the ink from the trough or reservoir by means of a brush, spreader blade, wire applicator or the like, and applying the ink to the engraved area of the printing plate. A doctor blade or other type of wiping or scraping device is then used to remove excess ink from the plate so that the ink remains only in the grooves or depressions which define the legend to be printed.

With a closed-reservoir ink assembly, the ink reservoir may be inverted and the printing plate positioned beneath the assembly so that the plate holds the ink within the reservoir. As the engraved image of the printing plate moves beneath the reservoir, the ink fills the engraving. Typically, the closed-reservoir ink assembly is provided with a doctoring edge that scrapes excess ink from the plate as the plate moves underneath the ink assembly. In some closed-reservoir ink assemblies the doctoring edge is provided on the inverted reservoir.

Many of the inks and/or paints used in a pad transfer printing process contain among other materials, pigments and solvents. Solvents, usually volatile in nature, maintain the ink or paint at a relatively low viscosity, thereby allowing for easy application and removal from the cliche plate. In a warm operating environment, such as a golf ball manufacturing facility, the ambient air temperature can reach a level that causes the solvent within the ink mixture to evaporate. As solvent evaporates, ink viscosity increases. As ink viscosity increases, when the doctor blade or other type of wiping or scraping device removes excess ink from the plate, the ink tends to smear on the plate resulting in poor ink/print transfer onto the ball. This results in machine downtime for cleaning, etc. which can be a time consuming process. In addition, evaporation of the solvents produces undesirable volatile vapor in the work environment.

### SUMMARY OF THE INVENTION

In accordance with the present invention, a pad printing machine is provided that comprises a pad transfer mechanism, an ink cup or reservoir, a cliche plate, a support plate, an excess ink removal device and an ink temperature control apparatus. The ink temperature control apparatus maintains the temperature of the ink at a predetermined level. The ink temperature control apparatus includes a temperature control element adapted to lower the temperature of the ink in the ink cup. A temperature sensor senses the temperature of either the ink in the ink cup or the ink cup surface. A signal is sent to the temperature control apparatus, which, based on the received signal, adjusts the temperature of the temperature control element to lower the temperature of the ink and maintaining the temperature of the ink at a level that reduces evaporation of solvents in the ink.

According to one aspect of the invention, the temperature control element comprises a unshaped channel formed in the support plate. The channel has an inlet end and an outlet end, and is adapted to circulate a chill fluid throughout the support plate. The chill fluid is circulated via a temperature control unit, such as a refrigerator, etc. The support plate can be a single plate or a plurality plates positioned side-to-side. In this case, each plate may have its own channel arrangement connect to the temperature control unit, and the temperature of each plate can be maintained at a different temperature if desired. An insulating material can be placed between adjacent plates to reduce heat transfer between the plates. A cliche plate is clamped to the top surface of the support plate and the temperature of the support plate controls the temperature of the cliche plate, thus controlling the temperature of the ink applied to the cliche plate.

According to another aspect of the invention, the temperature control element comprises a temperature conducting rod adapted to be inserted into the ink cup. The conducting is connected to a temperature control device. As the temperature of the ink in the ink cup rises, the temperature controller chills the conducting rod which is inserted into the ink cup to chill the ink.

According to a further aspect of the invention, the temperature control element comprises a heat pipe. The heat pipe includes a clamping element attached to the ink cup and a chilling unit located at a distance from the ink cup. The clamping element and the chilling unit are connected via a heat pipe.

According to another aspect of the invention, the temperature control element comprises a conducting coil formed around the ink cup. The conducting coil has an inlet for receiving chill fluid from a refrigerating unit and an outlet for delivering the chilling fluid back to the refrigerating unit.

According to another aspect of the invention, the temperature control element comprises a chilled air blower. The air blower is positioned next to the ink cup and chilled air is blown around the ink cup to control the temperature of the ink.

Each of the above-described aspects of the invention can be used independently or in combination.

The present invention also provides a method of controlling the temperature of ink in pad transfer. The method includes sensing the temperature of ink in an ink cup, either directly or indirectly. A signal representing the measured temperature is then sent to a temperature control unit. Based on the signal, the temperature control unit supplies a chilling medium to cool and maintain the temperature of the ink.

### BRIEF DESCRIPTION OF THE DRAWINGS

The above and additional objects and advantages of this invention will be more clearly understood from the following detailed description thereof when read in conjunction with the accompanying drawings in which:

FIG. 1 is a graph illustrating the relationship between printing ink viscosity and temperature.

FIG. 2 is a top view schematic diagram of one aspect of the present invention.

FIG. 3 is a plan view schematic diagram of the aspect of the invention of FIG. 1.

FIG. 4 is a top view schematic diagram of one alternative of the chiller plate of the present invention.

FIG. 5A-F illustrate in plan view the series of steps taken according to one aspect of the present invention.

FIG. 6 is another alternative of the chilling element of the present invention.

FIG. 7 is another alternative for the chilling element of the present invention.

FIG. 8 is another alternative for the chilling element of the present invention.

FIG. 9 is another alternative for the chilling element of the present invention.

FIG. 10 is another alternative for the chilling element of the present invention.

### DESCRIPTION OF THE INVENTION

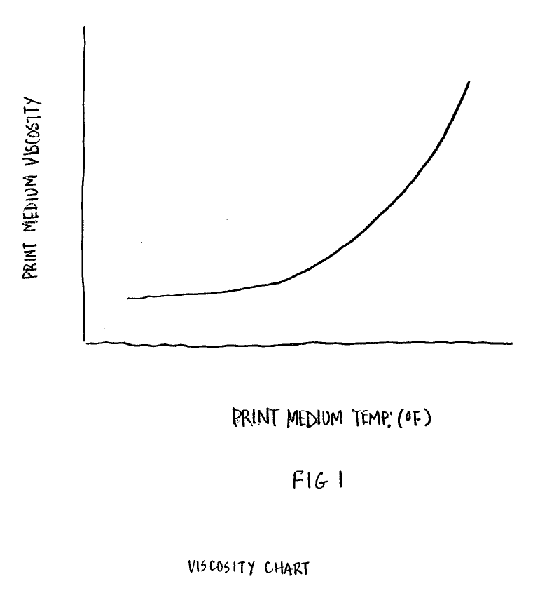

Referring to FIG. 1, the temperature of a solvent-based ink directly affects the viscosity of the ink. As the temperature of the ink increase, the solvents used in the ink to maintain a specific viscosity begin to evaporate out. As this evaporation takes place, the viscosity of the ink gradually increases, thereby increasing the likelihood of smearing, degrading the print transfer and making it more difficult to clean.

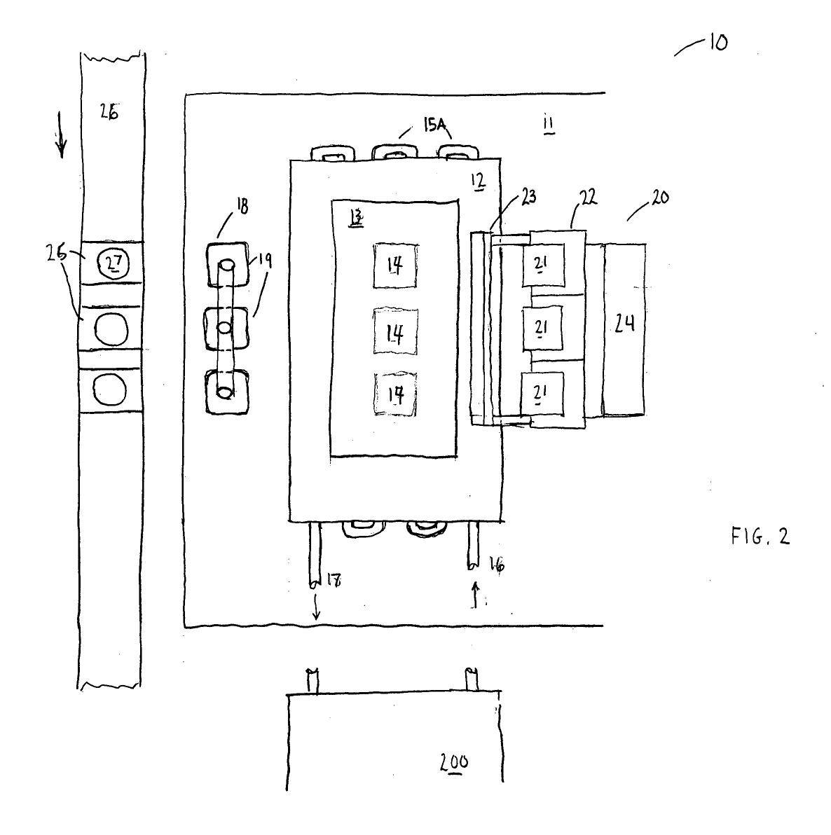

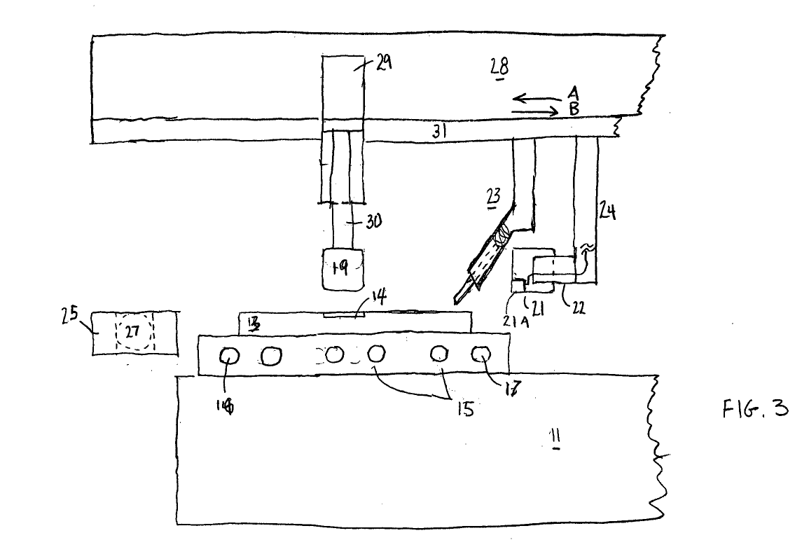

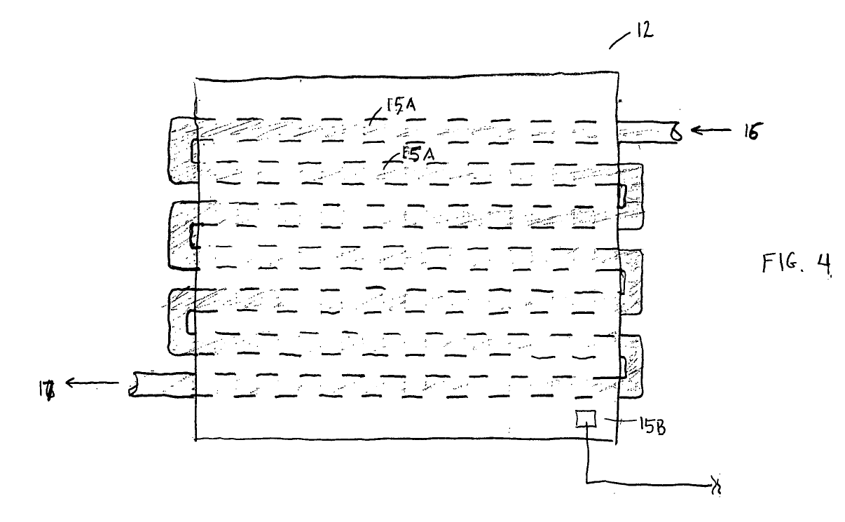

FIGS. 2-4 illustrate one aspect of the present invention. A pad printing machine 10 has a base 11. A support plate 12 is positioned on top of base plate 11. A cliché plate 13 is positioned on top of and is clamped to support plate 12. Cliché plate 13 carries one or more engraved areas 14 that represent the art work or other indicia that is to be printed on an object 27. As shown in FIG. 4, support plate 12 has a series of channels 15 formed therein, through which a unshaped piping assembly 15A is held. A temperature sensor 15B (FIG. 4) is mounted to support plate 12 to monitor the temperature of the surface of the plate. temperature sensor 15B generates signals representing the temperature of plate 12 and sends those signals to a refrigerator or similar cooling device 200. A cooling medium is circulated through piping assembly 15A. Refrigerator or similar cooling device 200 provides the cooling medium, preferably a fluid comprising a glycol composition, to an inlet end 16 of piping assembly 15A. The after looping back and forth through piping assembly 15A, it returns to refrigerator control unit 200 via outlet 17. The preferred temperature range for the ink is between about 30° F. to about 90° F.

A print transfer pad assembly 18 includes one or more print pads 19 adapted to pickup and transfer the ink image from engraved areas 14 and print the image on object 27. Object 27 can include a plurality of objects carried in nests 25 on a conveyor 26. Ink is supplied to engraved areas 14 through an ink transfer apparatus 20. Ink transfer apparatus 20 includes one or more ink cups or reservoirs 21 held in a clamping element 22. Clamp element 22 is held by an arm 24 to a frame 28, and is adapted to move in the direction of arrows A/B along a track 31. An optional ink wiper or doctor 23 is positioned adjacent to ink cups 21 to wipe excess ink from engraved areas 14. Ink cups 21 can be either open or closed cups as is generally known in the art and may carry a temperature sensor 21A that monitors the temperature of each ink cup 21. Print transfer pad assembly 18 includes a reciprocating arm 30 to which print pad 19 is attached. Reciprocating arm 30 is connected to a cylinder 29 adapted to reciprocate arm 30 via air, hydraulic fluid etc. Print transfer pad assembly 18 is attached to frame 28 and is adapted to move in unison with arm 24 and wiper 23 in the direction of arrows A/B.

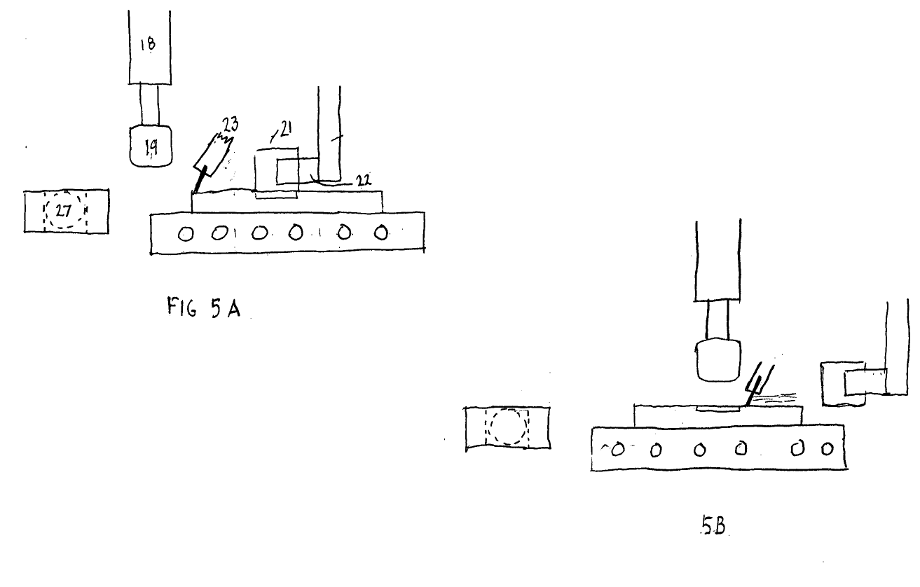

FIGS. 5A-F illustrate schematically a printing operation using the temperature control system according to the invention.

FIG. 6 illustrates schematically another embodiment of the invention. Since this aspect of the invention only relates to the support plate 12, the other elements of the printing device as illustrated in FIGS. 2 through 5 are the same herein. According to this embodiment of the invention, support plate 60 comprises three separate plates 61, 62, 63, each plate carrying a separate temperature sensor 61A, 62A, 63A respectively. Insulating material 64, 65 is positioned between adjacent plates to reduce or eliminate heat transfer between the plates. Each of plates 61, 62, 63 may have it's own channel arrangement, 66, 67, 68 respectively, each having it's own inlet and outlet ports 66A and B, 67A and B, and 68A and B, connected to the temperature control unit, and the temperature of each plate can be maintained at a different temperature if desired. A cliche plate is clamped to the top surface of each support plate and the temperature of each support plate controls the temperature of the adjacent cliche plate, thus controlling the temperature of the ink applied to the cliche plate.

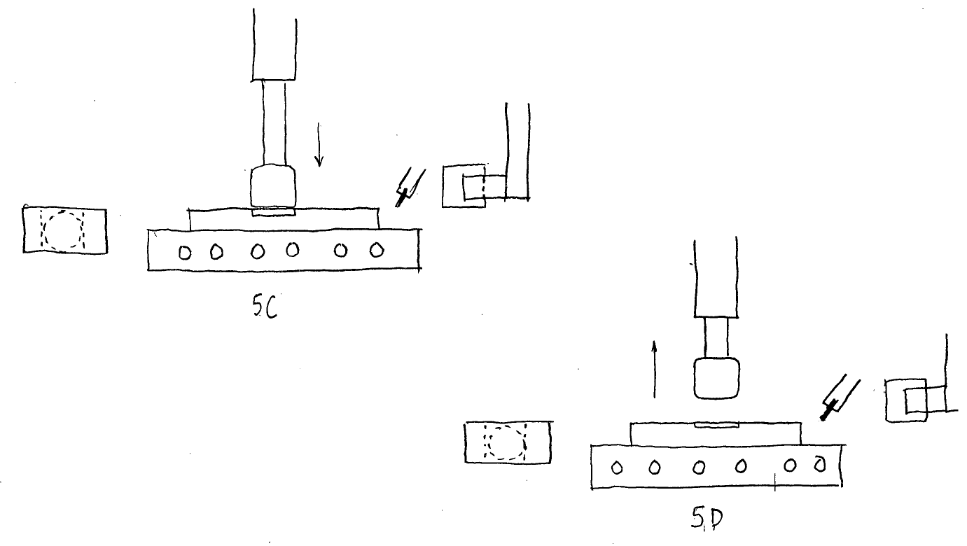

According to another aspect of the invention as illustrated in FIG. 7, the temperature control element comprises a temperature conducting rod 71 adapted to be inserted into the ink cup 21. The conducting rod 71 is connected to a runner 72, which is slideably mounted to track 73. A temperature sensor 71A is mounted to the ink cup and monitors the temperature of the cup. A signal generated by the temperature sensor 71A is sent to cooling device 200. As the temperature of the ink cup rises, the temperature controller chills the conducting rod 71 which is inserted into the ink cup to chill the ink therein.

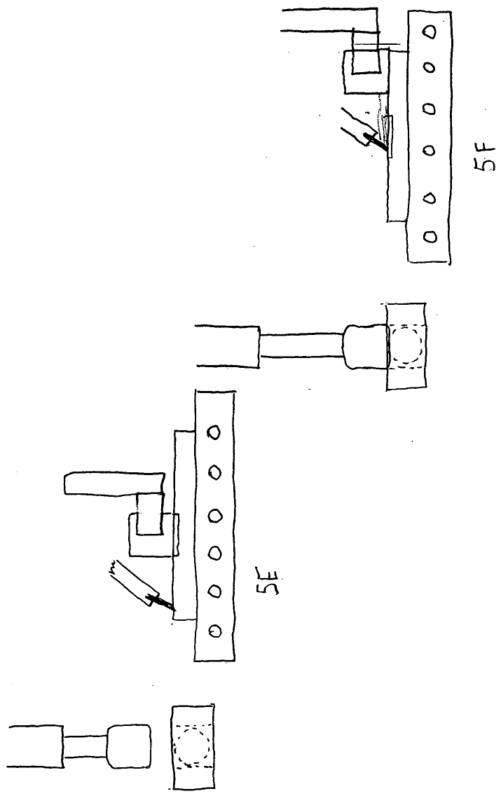

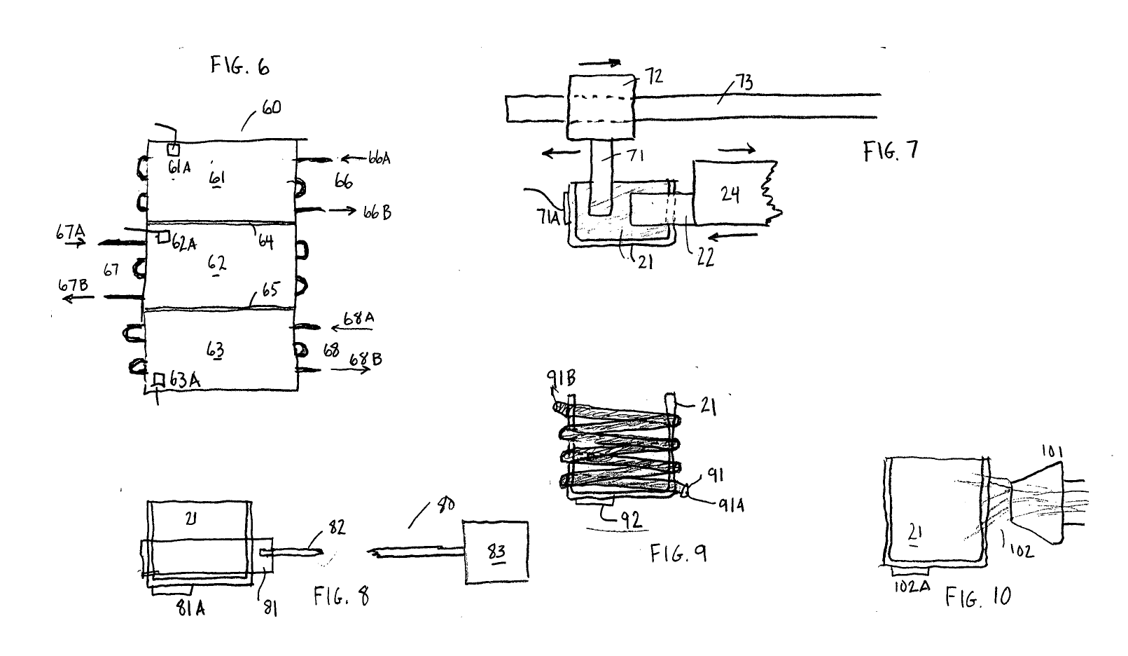

According to a further aspect of the invention as illustrated in FIG. 8, the temperature control element comprises a heat pipe device 80 connected to each ink cup 21. The heat pipe device 80 includes a clamping element 81 attached to the ink cup and a chilling unit 83 located at a distance from the ink cup. The clamping element 81 and the chilling unit 83 are connected via a heat pipe 81. A temperature sensor 81A monitors the temperature of the ink cup and generates a signal representing the temperature and sends the signal to cooler 200. Cooler 200 generates a control signal to chilling unit 83 through which chill medium is used to draw heat from ink cup 21 through heat pipe 82, thus chilling the ink cup.

According to yet another aspect of the invention as illustrated in FIG. 9, the temperature control element comprises a conducting coil 91 formed around the ink cup. The conducting coil 91 has an inlet 91A for receiving chill fluid from refrigerating unit 200 and an outlet 91B for delivering the chilling fluid back to refrigerating unit 200. A temperature sensor 92 monitors the temperature of ink cup 21 and sends a signal to refrigerating unit 200 to control the temperature of the ink cup.

According to another aspect of the invention as shown in FIG. 10, the temperature control element comprises a chilled air blower 101. The air blower 101 is positioned next to the ink cup and chilled air 102 is blown around the ink cup to control the temperature of the ink. Temperature of the ink cup is monitored by temperature sensor 102A.

While described above as separate temperature control elements, each of the described embodiments can be used individually or in any combination to control the temperature of the ink cups and ink contained therein.

The present invention also provides a method of controlling the temperature of ink in pad transfer. The method includes sensing the temperature of ink in an ink cup, either directly or indirectly. A signal representing the measured temperature is then sent to a temperature control unit. Based on the signal, the temperature control unit supplies a chilling medium to cool and maintain the temperature of the ink.

It is to be recognized and understood that the invention is not to be limited to the exact configuration as illustrated and described herein. For example, it should be apparent that a variety of suitable materials would be suitable for use in the composition or method of making the golf balls according to the Detailed Description of the Invention. Accordingly, all expedient modifications readily attainable by one of ordinary skill in the art from the disclosure set forth herein are deemed to be within the spirit and scope of the present claims.

1. An apparatus for controlling the temperature of an ink in a pad printing machine, comprising:
an ink reservoir;
a plate on which the ink reservoir is positioned;
a means for chilling ink contained within the reservoir to a predetermined temperature;
a temperature controlling element;
a temperature sensor to monitor the temperature of the ink in the ink reservoir and produce a signal representing the temperature; and
a cooling medium that controls the temperature of the ink based on the monitored temperature.

2. An apparatus for controlling the temperature of an ink in a pad printing machine according to claim 1, wherein the temperature controlling element comprises a plurality of channels formed in the plate through which the cooling medium passes.

3. An apparatus for controlling the temperature of an ink in a pad printing machine according to claim 1, wherein the plate comprises a plurality of adjacent plates, each having the means for chilling the ink.

4. An apparatus for controlling the temperature of an ink in a pad printing machine according to claim 1, wherein the temperature control element comprises a temperature conducting rod adapted to be inserted into the ink reservoir.

5. An apparatus for controlling the temperature of an ink in a pad printing machine according to claim 1, wherein the temperature control element comprises a temperature a heat pipe device connected to ink reservoir.

6. An apparatus for controlling the temperature of an ink in a pad printing machine according to claim 5, wherein the heat pipe device further comprises;
a clamping element attached to the ink reservoir;
a chilling unit; and
a heat pipe connecting the chilling unit to the clamping element.

7. An apparatus for controlling the temperature of an ink in a pad printing machine according to claim 1, wherein the temperature control element comprises a conducting coil formed around the ink reservoir.

8. An apparatus for controlling the temperature of an ink in a pad printing machine according to claim 1, wherein the temperature control element comprises a chilled air blower positioned next to the ink reservoir.

9. A pad printing machine, comprising;
a pad transfer mechanism;
an ink cup or reservoir for maintaining an amount of printing ink;
a cliche plate;
a support plate;
an excess ink removal device; and
an ink temperature control apparatus adapted to maintain the temperature of the ink at a predetermined level.

10. The ink temperature control apparatus according to claim 9, further comprising:
a chiller unit;
a temperature control element adapted to lower the temperature of the ink in the ink cup; and
a temperature sensor that senses the temperature of either the ink in the ink cup or an ink cup surface and generates a signal that is sent to the temperature control apparatus;
wherein, based on the received signal, adjusts the temperature of the temperature control element to change the temperature of the ink and maintain the temperature of the ink at a level that reduces evaporation of solvents in the ink.
